(19) United States
(12) Patent Application Publication
(10) Pub. No.: US 2019/0079490 A1
(43) Pub. Date: Mar. 14, 2019

(54) CREATING AND DESIGNING BIRTHDAY CANDLES

(71) Applicant: Adolph RODRIGUEZ, Elmont, NY (US)

(72) Inventor: Adolph RODRIGUEZ, Elmont, NY (US)

(21) Appl. No.: 15/700,905

(22) Filed: Sep. 11, 2017

(51) Int. Cl. G05B 19/4099

(52) U.S. Cl. CPC G05B 19/4099; G05B 2219/35066; G05B 2219/49023

(57) ABSTRACT

Systems and methods are provided for manufacturing candles. The method includes receiving, using a graphical user interface, a set of candle specifications input by a user, creating a 3-dimensional data file based on the set of candle specifications, printing, using a 3-dimensional printer, one or more models corresponding to one or more pieces of a candle, forming one or more molds corresponding to the one or more models, casting one or more wax pieces using the molds, and assembling the one or more wax pieces.

### CLAIM OF PRIORITY

This application is a United States non-provisional application and claims no priority to any previous patent or patent application.

### FIELD OF THE EMBODIMENTS

This invention relates to candle manufacturing and, in particular, to a multifaceted system for designing and creating candles.

### BACKGROUND OF THE EMBODIMENTS

Candles are used for a variety of occasions, not the least of which is for birthdays. Birthday cakes, as well as other celebratory cakes, are often custom-designed to show specific words, pictures, and other graphics. However, most candles come is a standard format and are not customized to a particular event, person, etc. Therefore, an easy and efficient means by which customizable candles can be ordered is needed.

Examples of related art are described below:

U.S. Pat. No. 2,527,706 generally describes an improved candle holder, and particularly, to a candle holder susceptible to a plurality of mounting arrangements to permit the decorative effects thereof to be conveniently varied by the user.

U.S. Pat. No. 4,721,455 generally describes a cake cover and candle support a cylindrical center support configured to be inserted into a birthday cake or the like and defining an extended portion. A planar cake cover defines a center aperture and a plurality of candle receiving recesses. The cake cover is received upon and supported by the center support above the upper surface of a cake.

U.S. Pat. No. 5,910,005 generally describes a method for forming candles according to the invention includes four basic steps: providing a candle core; heating a working area on the outer surface of the candle core such that the working area is pliable; sculpturing a portion of the working area; and reheating the working area with a readily available household heating implement whenever the working area of the candle falls below a desired temperature. A candle core is comprised of multiple inner layers of distinct color and composition, an outer surface preferably having a pliable temperature range of about 120 to 125° Fahrenheit, and a wick extending from a top end and wound into a loop. Because the pliable temperature range of the candle core is relatively low, the candle core need only to be preheated by submerging it a in hot water bath prior to sculpturing. Additionally, the outer surface of the candle core may be reheated anytime during sculpturing using a hair dryer or other readily available household heating source. To facilitate the sculpturing and reheating steps, a sculpturing stand is provided from which the candle core may be suspended by engaging the wick loop with a hook on an elevated member of the sculpturing stand.

U.S. Pat. No. 6,937,152 generally describes systems and methods for an electronic doll-house to be constructed at a reasonable cost that provides the ability to identify the location of a number of figures that a child may manipulate in a play space. By use of IR communications and the characteristics of such a communications link, a doll-house is provided that combines the ability to be built at a relatively low cost with the advantages of not requiring physical contacts, special purpose RFID chips and transceiving arrangements, or other expensive sensing methods.

In brief, the invention makes use of an IR transmitter at sends a unique ID code upon user activation which allows for power savings, the elimination of contact points or RF components, the localization of the signal to a room in a doll-house, and by use of reflecting paths, allows relative independence of orientation. These capabilities are that of a low cost system that allows a system controller to locate an object within a doll-house and consequently allow for an improved location and/or player object specific game play.

U.S. Pat. No. 7,999,825 generally describes a distributed color selection and coordination system including a remote computer communicatively coupled to a server. The remote computer configured to select a starting color and access a database in the server to find one or more complementary colors. The colors in the database are arranged in a predetermined relationship with other colors in the database, the relationship between colors based on color theory. The remote computer is capable of storing personal information and color selections on the server. An in-store kiosk is communicatively coupled to the server and configured to execute color selection and coordination software. The in-store kiosk is further capable of retrieving stored personal information and color selections from the server which were previously stored from the remote computer.

U.S. Pat. No. 8,377,360 generally describes software and mechanics, and more specifically, to systems and methods for providing a personal affector machine. In one embodiment, the invention includes a top frame; a cross-member, the cross-member extending from the top frame, the cross-member configurable to do any of translate and rotate relative to the top frame; an affector head, the affector head coupled to the cross-member, the affector head configurable to do any of translate, rotate, and gyrate relative to the top frame, the affector head having an affector; a bottom frame, the bottom frame coupled to the top frame; and a cassette, the cassette configurable to removably securing material therein, the cassette being removably attachable to the bottom frame, wherein the affector is configurable to affecting the material within the cassette in a plurality of dimensions.

U.S. Pat. No. 8,551,194 generally describes a candle and process for making it. The candle comprises prated wax particles, comprising hydrogenated natural oil and wherein at least 75% of the prilled wax particles are less than 800 μm in diameter. The candle includes a compressed core and a thermally fused outer layer.

U.S. Patent Publication No. 2006/0125420 generally describes a candle emulation device that comprises a light source, a light source controller and an optional fragrance-release mechanism. The light source controller is coupled to the light source and is adapted to control the light source in order to produce a lighting effect that emulates lighting from a candle flame. The fragrance-release mechanism is adapted to release a fragrance into air surrounding the candle emulation device.

U.S. Patent Publication No. 2008/0036116 generally describes a mold for forming a candle body having a design embossed on at least one surface thereof. The mold includes a mold body having at least one inner side surface defining a mold cavity open at its top for receiving liquefied candle wax. The mold also includes an embossing mold having an embossing surface for forming the embossed design on the surface of the candle. A securing component provides for selectively securing the embossing mold to the inner side surface of the mold body such that the embossing mold may be secured to the mold body at any location on the inner side surface.

U.S. Patent Publication No. 20080228599 generally describes a system embodied as a website including a first, second and third pluralities of display screens, the first enabling an at-home user to select a first color which coordinates with a second selected color, the second enabling the user to select for purchase one or more of a plurality of interior decorating-related items, and the third enabling the user to order and pay for one or more of (a) a paint sample of each of said first and second colors and (b) at least one of the interior decorating-related items. The order may be automatically transmitted to a fulfillment -enter for fulfillment and then delivered to the user.

U.S. Patent Publication No. 2009/0069929 generally describes a system and method for creating customized, multimedia greeting cards via a kiosk. Template data, associated with greeting card templates, and multimedia data files are first stored in an associated data storage. Indicia are then generated on an associated display corresponding to the greeting card templates. Selection data is received corresponding to a selected greeting card template and a multimedia file is associated with the selected greeting card template. Customization data corresponding to user selected content associated with the selected greeting card template is then received. A greeting card output is thereafter generated in accordance with the received selection data, customization data, and the associated multimedia data file. The greeting card output also includes a visual representation of the selected greeting card template and customization data, as well as an encoding of the multimedia data file.

U.S. Patent Publication No. 2014/0199646 generally describes a festive cake decoration and wax-type confection made of a complex mixture of waxes, organic fibers, sweeteners, and which optionally includes at least one natural gum. The invention is capable of carrying and sustaining a flame when placed adjacent to a source of combustion. Once the invention is lit, the food matter of the invention oxidizes at a temperature of 125° F. (52° C.).

U.S. Patent Publication No. 2016/0131359 generally describes an inexpensive disk for holding and buoyantly supporting a candle in a beverage, in particular for small birthday candles. The disk is formed of a flat sheet of inexpensive and disposable material with a central aperture having grippers for holding the candle. The disk may be embossed with numbers or letters signifying a special event.

U.S. Patent Publication No. 2016/0353763 generally describes an edible candle kit includes an emblematic mold, a multi-phase edible composition, a candle, and a candle holder; the multi-phase edible composition having a liquid state and a solid state. The multi-phase edible composition is melted into the liquid state, wherein the emblematic mold is used to shape and retain the multi-phase edible composition as the multi-phase edible composition is transformed into the solid state. The multi-phase edible composition being in the solid state is then removed from the emblematic mold and a candle holder is positioned onto the multi-phase edible composition. The candle is then positioned into a receiving volume of the candle holder, wherein the candle is retained on top of the multi-phase edible composition in an upright position.

Various systems and methodologies are known in the art. However, their structure and means of operation are substantially different from the present disclosure. The other inventions fail to solve all the problems taught by the present disclosure. At least one embodiment of this invention is presented in the drawings below and will be described in more detail herein.

### SUMMARY OF THE EMBODIMENTS

According to an aspect of the present invention, a method is provided for manufacturing candles. The method includes receiving, using a graphical user interface, a set of candle specifications input by a use, creating a 3-dimensional data file based on the set of candle specifications, printing, using a 3-dimensional printer, one or more models corresponding to one or more pieces of a candle, forming one or more molds corresponding to the one or more models, casting one or more wax pieces using the molds, and assembling the one or more wax pieces.

According to another aspect of the present invention, a system is provided for manufacturing candles. The system includes an electronic device including a graphical user interface configured to receive a set of candle specifications input by a user, a processor, coupled to a memory, configured to create a 3-dimensional data file based on the set of candle specifications, and a 3-dimensional printer configured to print one or more models corresponding to one or more pieces of a candle, wherein the one or more models are configured to enable one or more molds to be formed from the one or more models.

It is an object of the present invention to provide the method for manufacturing candles, wherein the set of candle specifications includes one or more input variables selected from the group consisting of wax type, candle size, lettering, numbering, visual graphics, wick type, shape of candle, and number of wicks.

It is an object of the present invention to provide the method for manufacturing candles, wherein the visual graphics include one or more image files.

It is an object of the present invention to provide the method for manufacturing candles, Wherein the receiving further includes uploading the one or more image files.

It is an object of the present invention to provide the method for manufacturing candles, wherein the method further includes printing the visual graphics onto the candle.

It is an object of the present invention to provide the method for manufacturing candles, wherein the graphical user interface is housed on a mobile electronic device.

It is an object of the present invention to provide the method for manufacturing candles, wherein the 3-dimensional printer is a stereolithographic printer.

It is an object of the present invention to provide the method for manufacturing candles, wherein the one or more models include one or more materials selected from the group consisting of plastic resin and laser sintered nylon.

It is an object of the present invention to provide the method for manufacturing candles, wherein the assembling the one or more wax pieces further includes applying an adhesive to the one or more wax pieces.

It is an object of the present invention to provide the method for manufacturing candles, wherein the assembling the one or more wax pieces further includes applying a pressure to each of the one or more wax pieces.

It is an object of the present invention to provide the system for manufacturing candles, wherein the set of candle specifications includes one or more input variables selected from the group consisting of wax type, candle size, lettering, numbering, visual graphics, wick type, shape of candle, and number of wicks.

It is an object of the present invention to provide the system for manufacturing candles, wherein the visual graphics include one or more image files.

It is an object of the present invention to provide the system for manufacturing candles, wherein the graphical user interface is further configured to enable a user to upload the one or more image files.

It is an object of the present invention to provide the system for manufacturing candles, wherein the system further includes a graphics printer configured to print the visual graphics onto the candle.

It is an object of the present invention to provide the system for manufacturing candles, wherein the graphical user interface is housed on a mobile electronic device.

It is an object of the present invention to provide the system for manufacturing candles, wherein the 3-dimensional printer is a stereolithographic printer.

It is an object of the present invention to provide the system for manufacturing candles, wherein the one or more models include one or more materials selected from the group consisting of: plastic resin; and laser sintered nylon.

It is an object of the present invention to provide the system for manufacturing candles, wherein the system further includes an adhesive configured to secure one or more wax pieces formed from the one or more molds.

It is an object of the present invention to provide the system for manufacturing candles, wherein two or more of the one or more pieces of the candle include an interlocking mechanism for interlocking the two or more pieces.

### BRIEF DESCRIPTION OF THE DRAWINGS

FIGS. 1-2 show a flowchart of a method for designing candles, according to an embodiment of the present invention.

FIG. 3 shows a flowchart of a method of manufacturing components of a candle, according to an embodiment of the present invention.

FIG. 4 shows a method of assembling a candle, according to an embodiment of the present invention.

FIG. 5 shows a system for manufacturing candles, according to an embodiment of the present invention.

FIGS. 6-35 show alternate embodiments of interlocking pieces including multiple letters, according to various embodiments of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

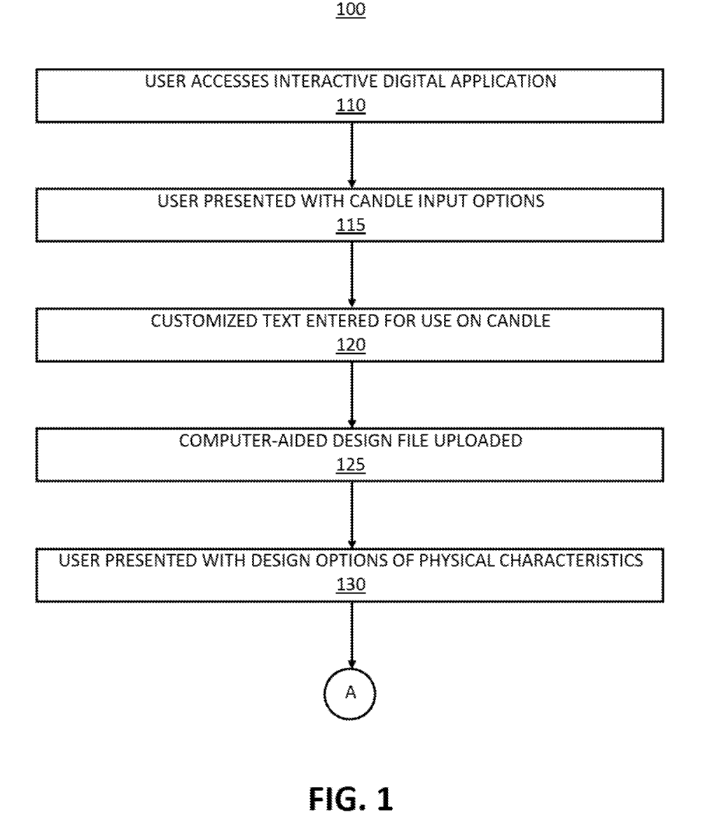

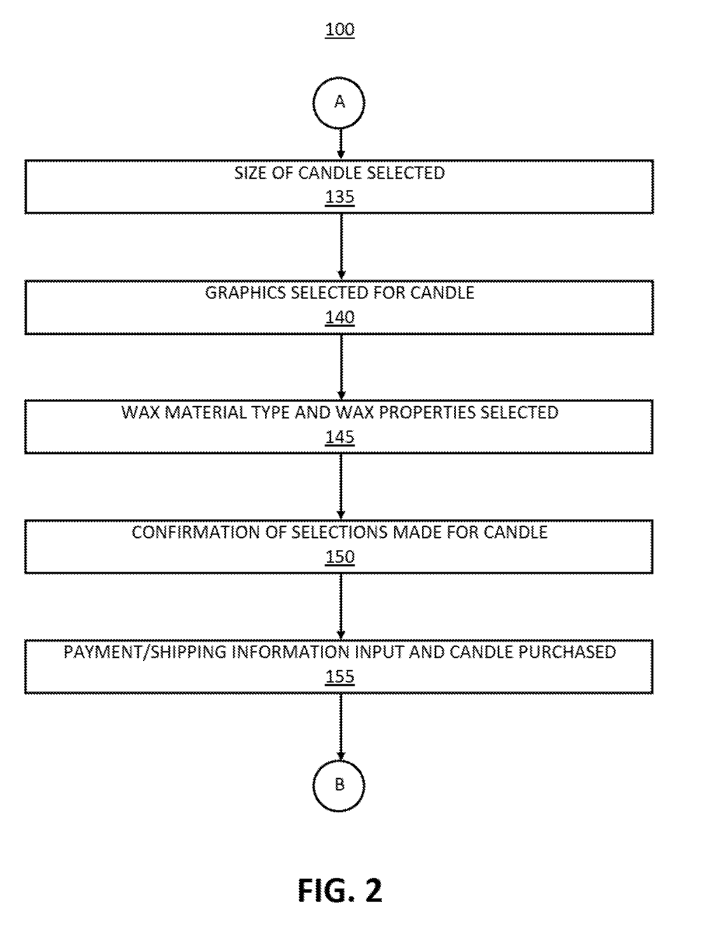

Referring now to FIGS. 1-2, a flowchart 100 of a method for designing candles is illustratively depicted, in accordance with an embodiment of the present invention.

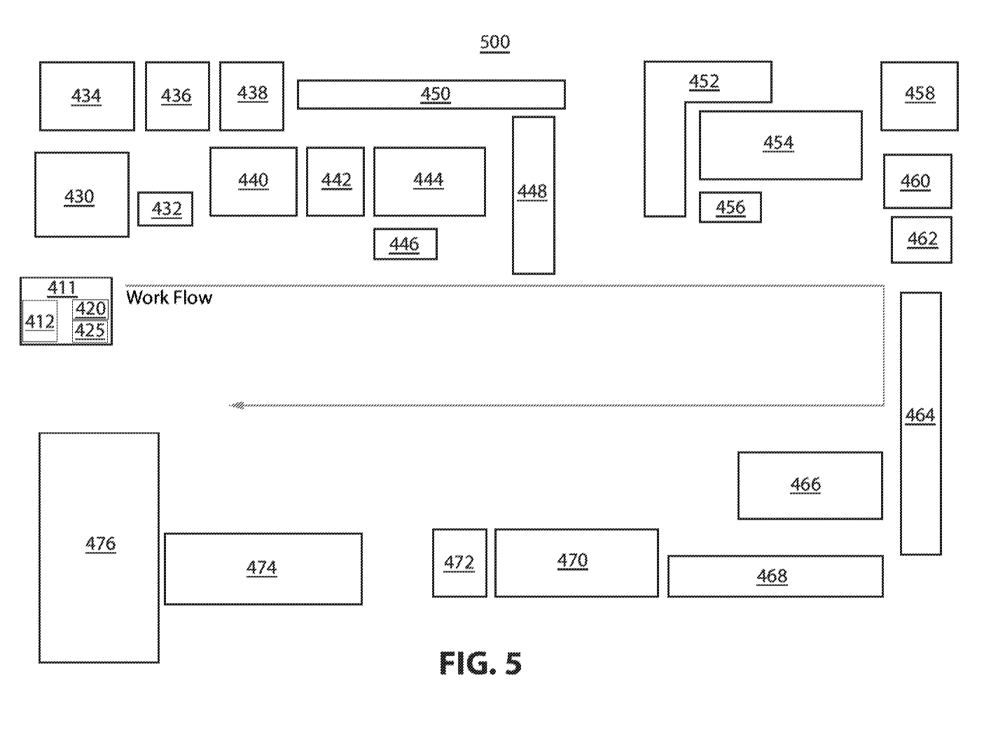

At step 110, a user accesses an interactive digital application. This application is accessible on any suitable electronic device 411 (shown in FIG. 5) such as, but not limiting to, a personal computer, a laptop, a tablet computer, a cell phone, direct email or telephone, or mobile electronic device, etc. According to an embodiment, the digital application is in the form of an online website.

The digital application includes a graphical user interface 412 (shown in FIG. 5) which is configured to enable a user to customize an order for one or more candles. According to an embodiment, the digital application is integrated with Computer-Aided Design (CAD) or other 3D computer architecture software (such as, e.g., Solidworks Google Sketch up, etc.). According to an embodiment, the digital application includes digital graphics software such as, e.g., Adobe Photoshop or other suitable software.

Multiple types of candles may be selected and/or customized. These candles may include, e.g., candles to celebrate birthdays, anniversaries, sports team celebrations, work celebrations, and/or any other appropriate celebration and/or event. The candles may also include scented candles, decorative candles, and custom-shaped candles. According to an. embodiment, the shapes may include, e.g., letters, words/proper nouns, symbols, etc. According to an embodiment, the candles may be customizable into specified forms. These forms may include, e.g., cylindrical shapes and/or forms and figures which include materials which may be injected into a mold and/or may be used in a non-candle capacity (i.e., soap, plastic plaques, cake toppers, etc.).

At step 115, several options for candle input data are presented to the user. According to an embodiment, the input data may include a list of pre-determined candle templates. These standard templates may include options for the insertion of an image, letters, anchor numbers to customize the candle. The input may also include selecting the occasion for which the candle is to be used.

At step 120, the user enters customized text to be used in the candle's creation. According to an embodiment, the user further determines the location of the text on the candle. The text may include letters, numbers, and/or symbols.

At step 125, the user may input or electronically upload a computer-aided design (CAD) file indicating a 2- or 3-Dimensional shape of the candle to be ordered. The CAD file may be a premade CAD file that selected from a list of CAD files and/or a CAD file custom-made by the user.

At step 130, the user is presented, onto the graphical user interface, with one or more design options and selects the physical characteristics of the desired candle. According to an embodiment, the physical characteristics include wick type, placement, and quantity. This may include which letter or letter atop which the wick or wicks will sit, what type of wick or wicks are to be used (standard wick, sparkler, etc.), etc.

According to an embodiment, the physical characteristics may include that and other visual characteristics which may include, hut are not limited to, font and typeface, letter shape/properties (flat letter faces, rounded letter faces, bubble letters, etc.), alignment and orientation (horizontal/vertical, flat/curved, offset (wherein the letter or letters do not align along the y-axis horizontally or along the x-axis vertically), etc.).

According to an embodiment, the user's physical characteristics selections create subsequent requests for further customization. For example, if a user selects a template featuring flat faced letters, an Arial font, offset in an arc, the user may then be presented with an option to change the font, selected rounded letter faces, and/or augment or reduce the degree of the arc, among other possible options.

At step 135, the user selects the desired size of the candle. According to an embodiment, the size of the candle is determined by the customer's input via the rendering software. According to an embodiment, the selected candle size enables subsequent optional options for selection by the user. For example, several letter sizes may be available for the user to choose from should the user prefer to manually select the size of the letters. The user may also select that the letter size be automatically selected based on the candle's selected criteria, such as, e.g., candle height, width, diameter, etc.

At step 140, once the shape, properties, and size of the desired candle have been confirmed, the user is prompted to select the graphics for the candle. Options for the graphics include, but are not limited to, a custom graphics upload (e.g., the is enabled to upload pictures and/or artwork, in a number of standard file formats such as, e.g., .jpg, .img, .pdf, etc.) and template themes. The template themes may include, but are not limited to, general sports graphics (footballs, soccer ball patterns, hockey stick and puck, etc.), team-specific sports graphics, fictional character graphics, real and/or historical figure graphics, animals (tigers, leopards, zebra prints, etc.), and/or any other suitable graphics.

Once the graphic is selected it will then be automatically superimposed and centered onto an evolving 3D model of the candle. According to an embodiment, once the user selects the graphics, the user is enabled to have the option to alter the graphics characteristics. The options for altering the graphics characteristics may include, but are not limited to, resizing the graphics, realigning/centering the graphics, rotating the graphics, changing a color pallet/scheme (if applicable) of the graphics, and/or any other relevant graphics characteristics.

According to an embodiment, at step 145, the customer may be prompted with a range of customizable options and/or may be prompted to select a wax material type and/or wax properties for the candle, such as, but not limited to, traditional paraffin, flexible wax, rigid-plastic-like wax, and/or any other relevant wax material types and/or wax properties. The wax material type and/or wax properties may dictate wick type compatibility and cake-mounting options for the candle.

At step 150, once all customization options have been selected, the user confirms the selections made for the desired candle. According to an embodiment, the confirmation includes presenting the user with a digital visual inspection of a 3D model of the candle from all angles that will be made using the selections made by the user.

At step 155, the user makes the purchase of the candle. According to an embodiment, this purchase includes inputting any necessary billing and/or shipping information using the graphical user interface.

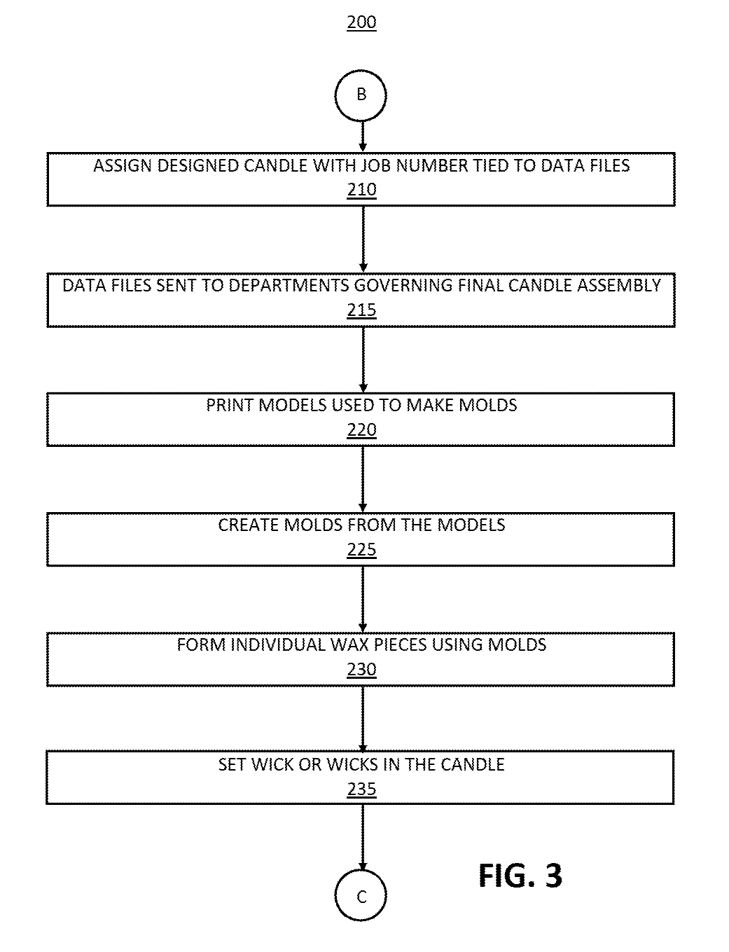

Referring now to FIG. 3, a flowchart of a method 200 of manufacturing components of a candle is illustratively depicted, in accordance with an embodiment of the present invention.

At step 210, the candle designed using method 100 is assigned a job number corresponding to the user's order. According to an embodiment, the electronic device 411 used to enable the user to input the set of candle specifications sends the information to a computing device 412, which may include a processor 420 and a memory 425 (shown in FIG. 5). According to an embodiment, the processor is configured to create one or more data files corresponding to the selections made by the user. According to an embodiment, the job number is tied to two data files. According to an embodiment, the two data files are generated, created, and separated by the application.

According to an embodiment, the two data files include the 3D model of the candle (stereolithography (STL) or other similar format) and/or a 2D image of the face of the candle with the graphics overlay.

According to an embodiment, at step 215, once the user has confirmed purchase (step 155, FIG. 2), the two data files are sent to the departments governing the final assembly and direct to substrate (DTS) printing.

Though the user sees the candle as a cohesive whole during the ordering process, the manufacturing process treats each candle as a sum of pre-fabricated parts. As such, the STL file received by the assembly department defines these parts by their individual stock keeping unit numbers corresponding to wax pieces to be assembled.

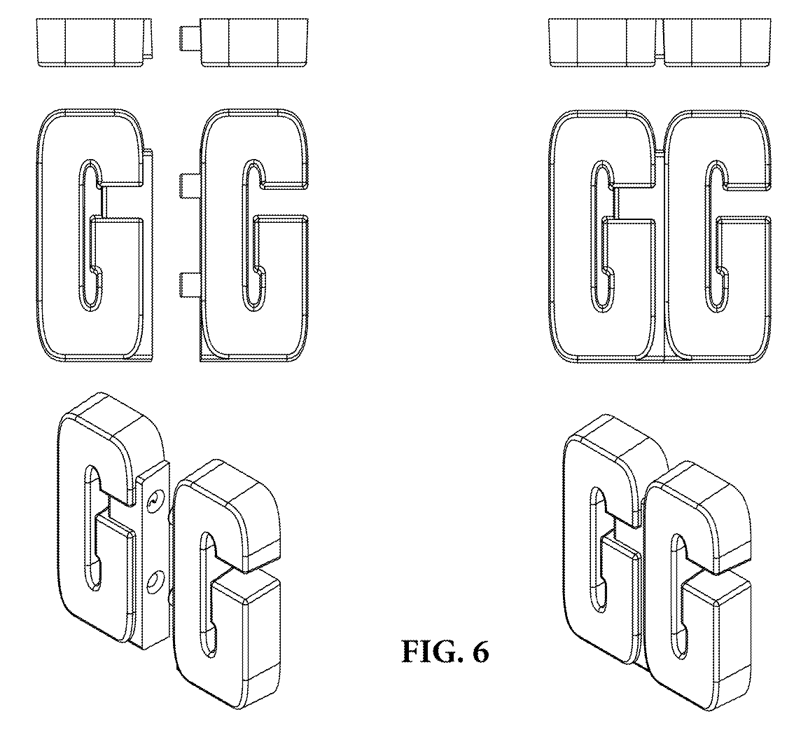

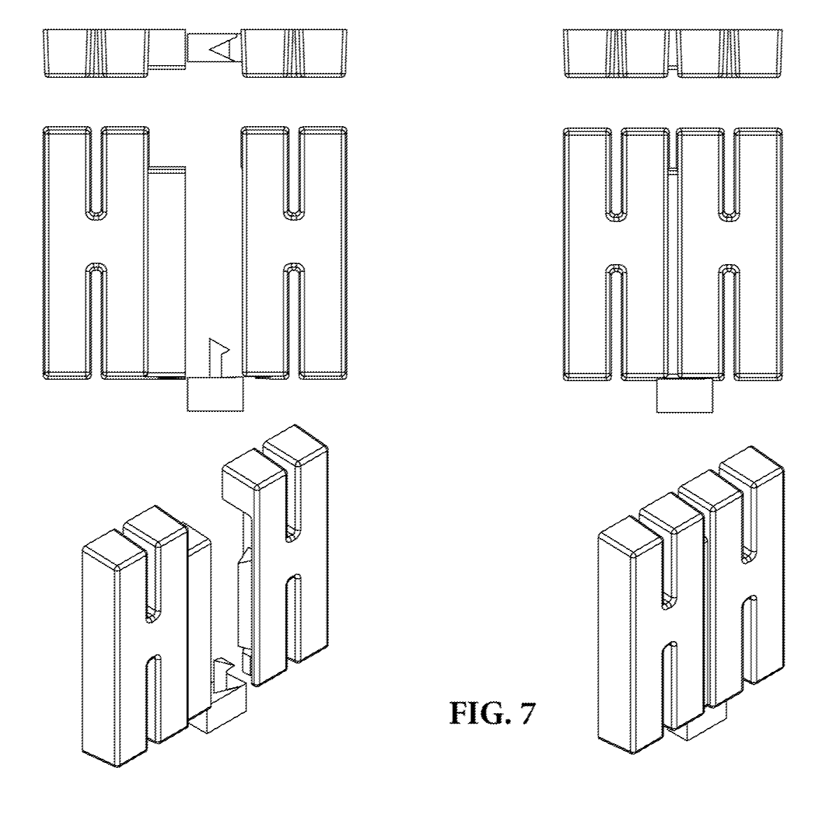

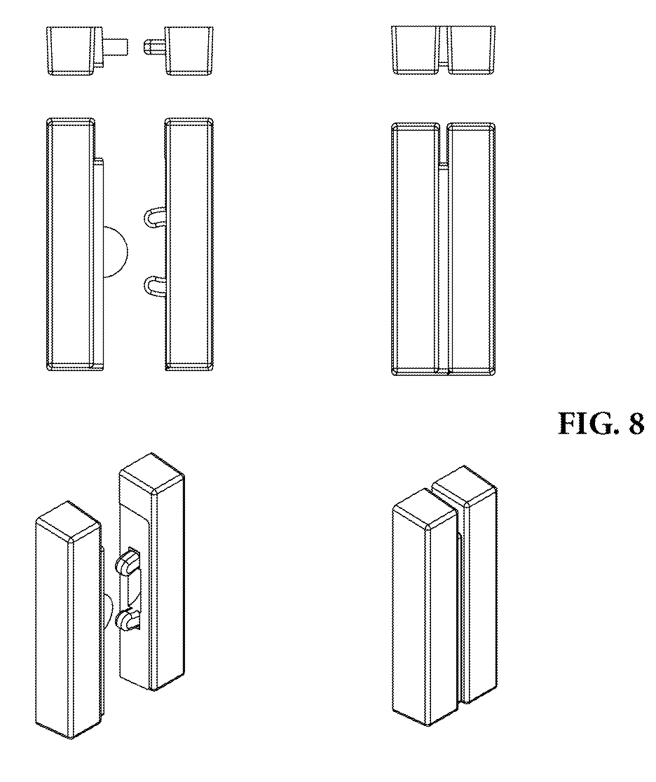

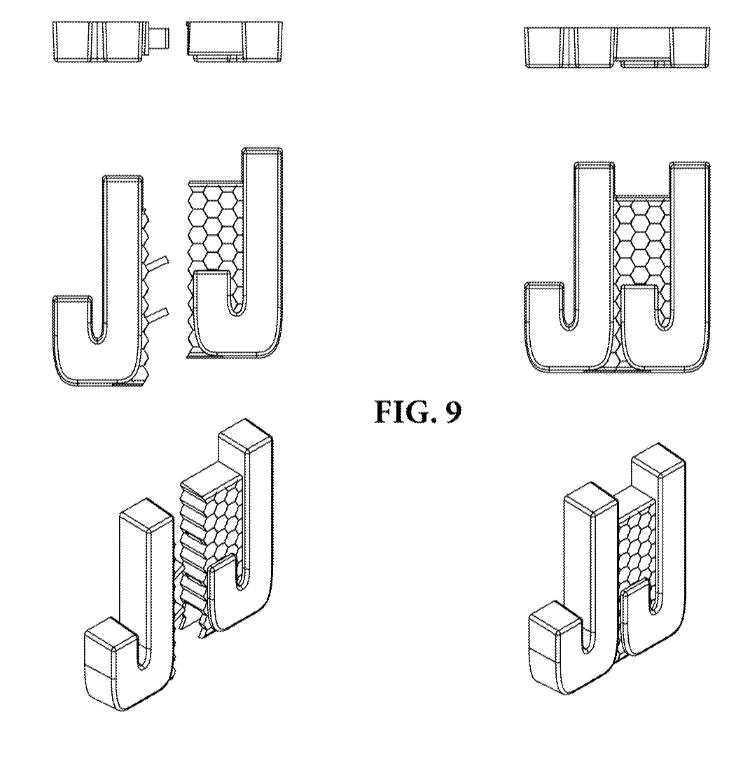

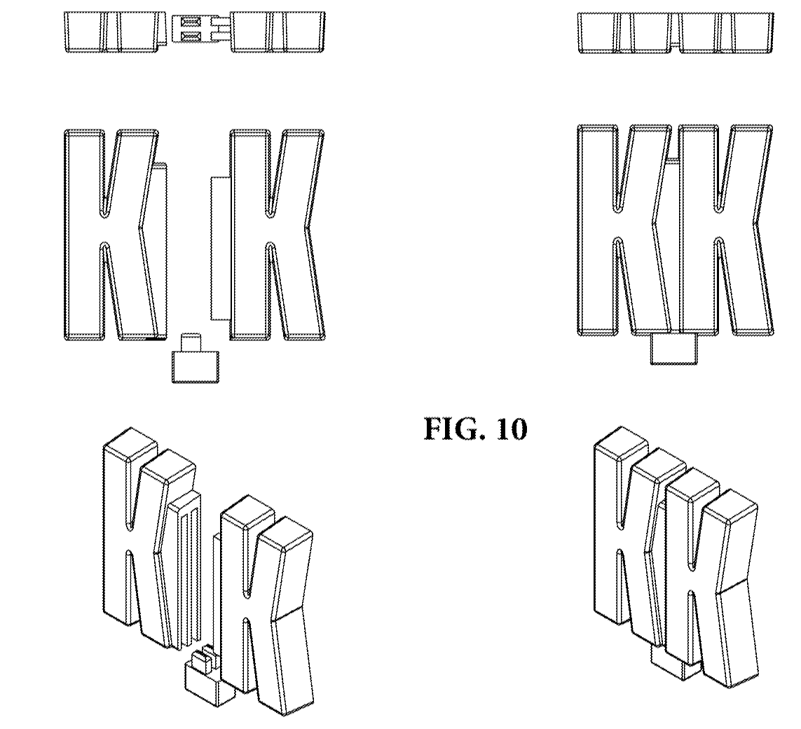

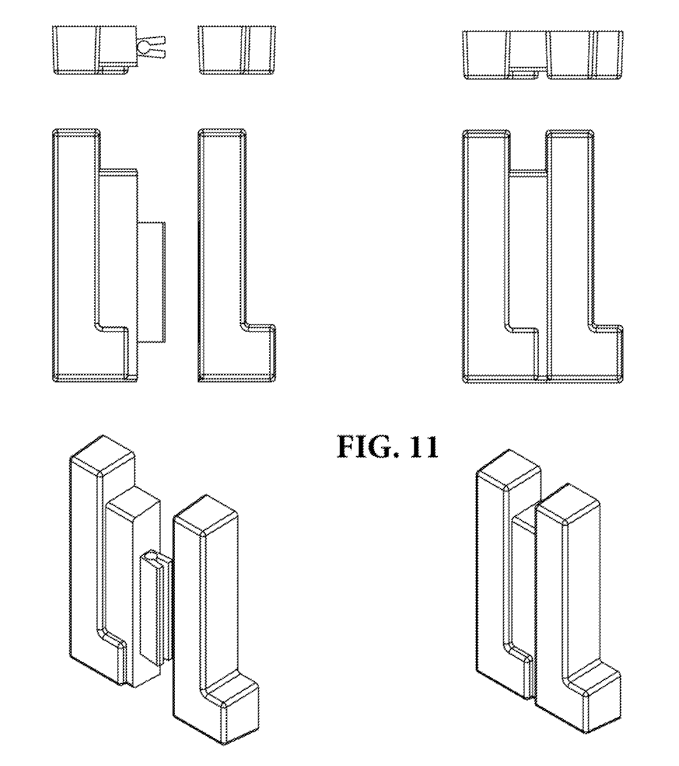

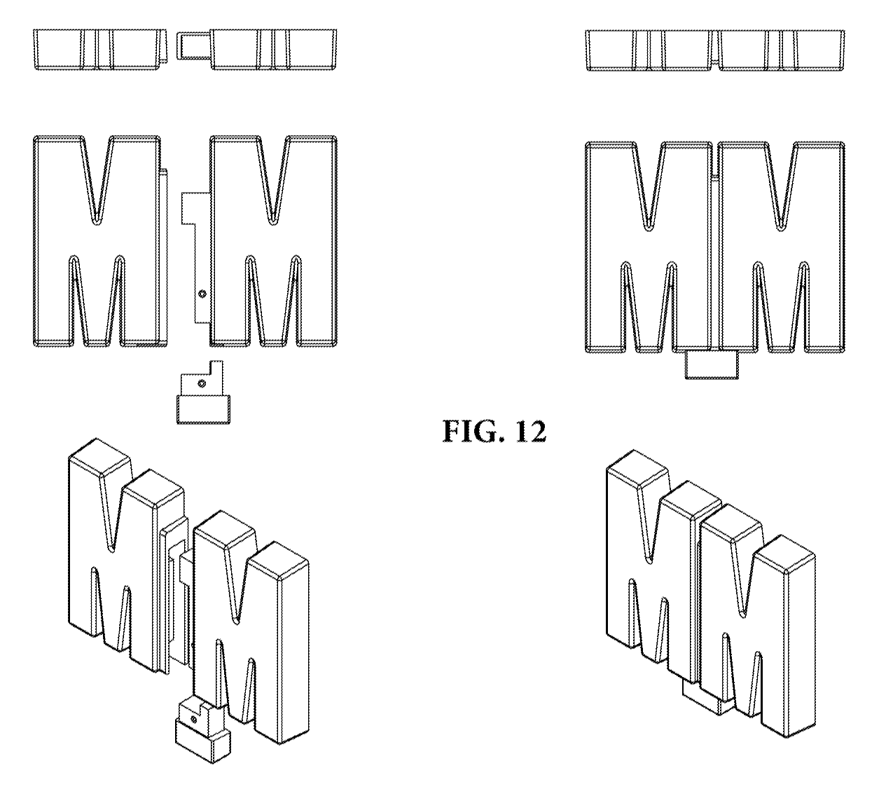

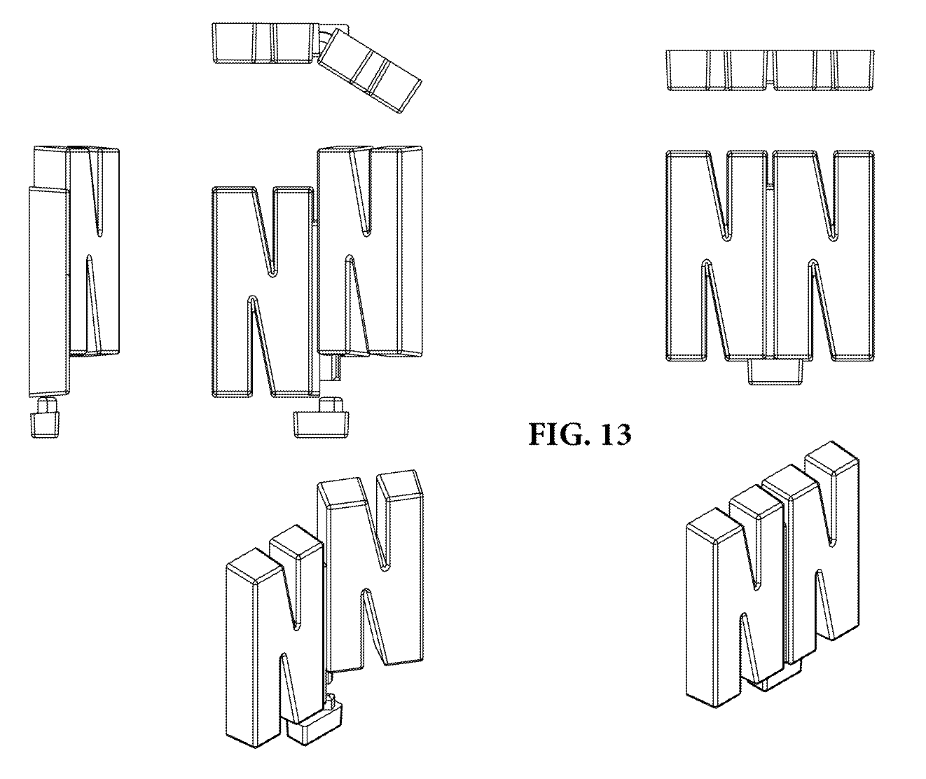

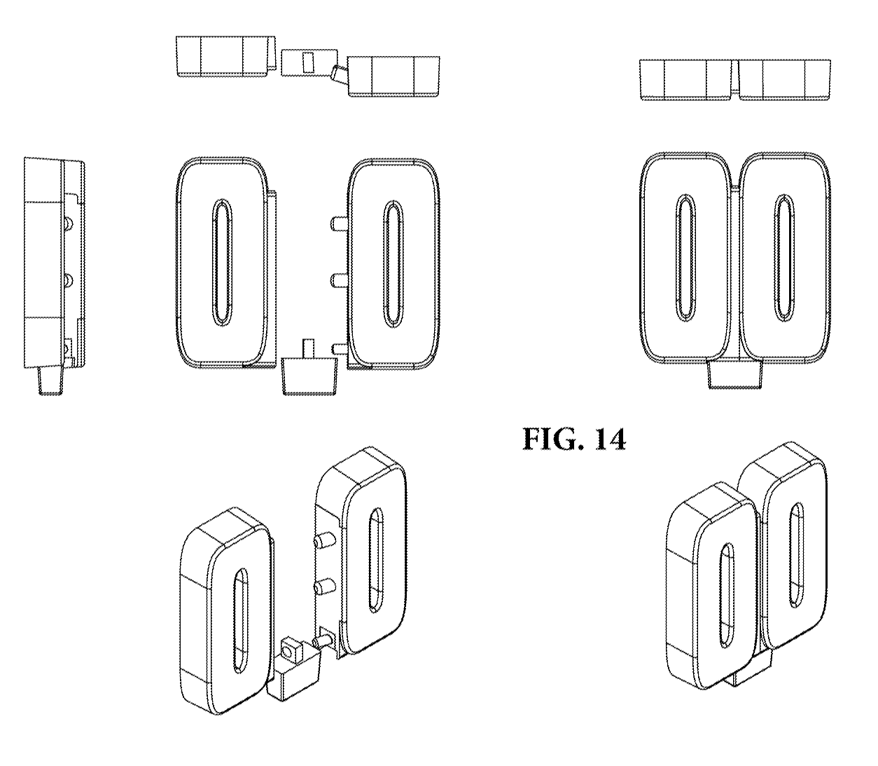

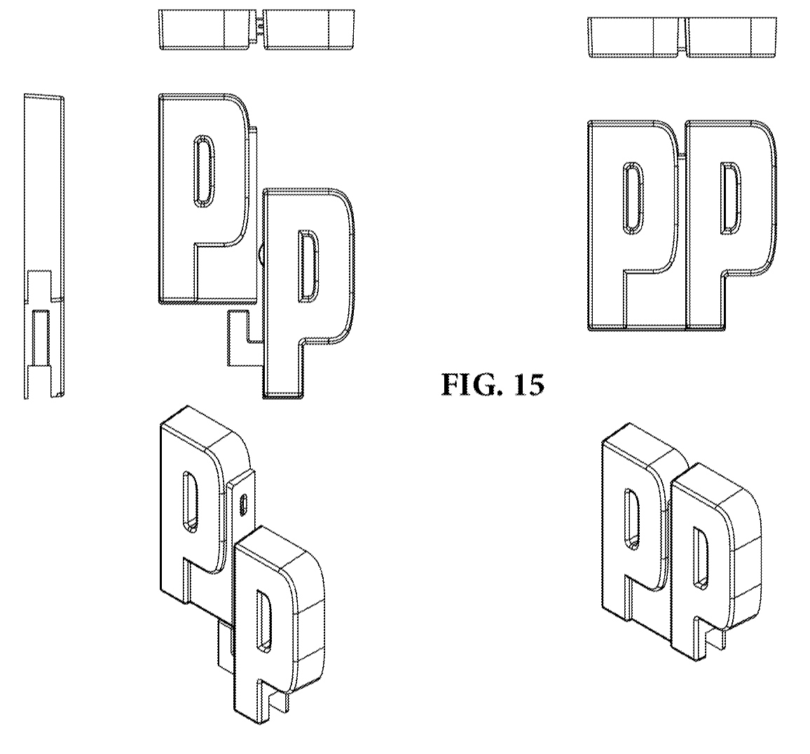

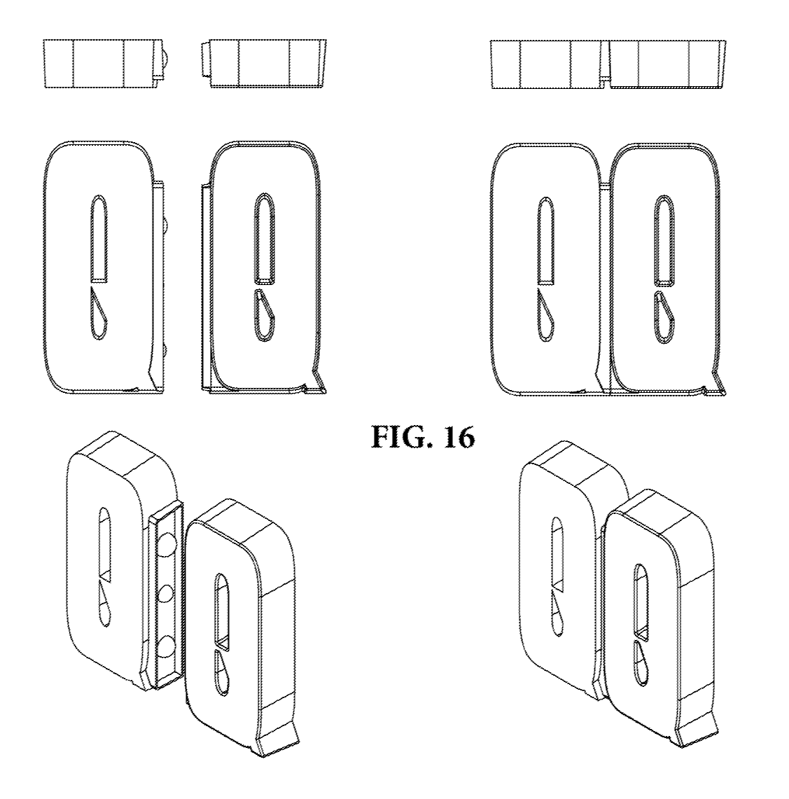

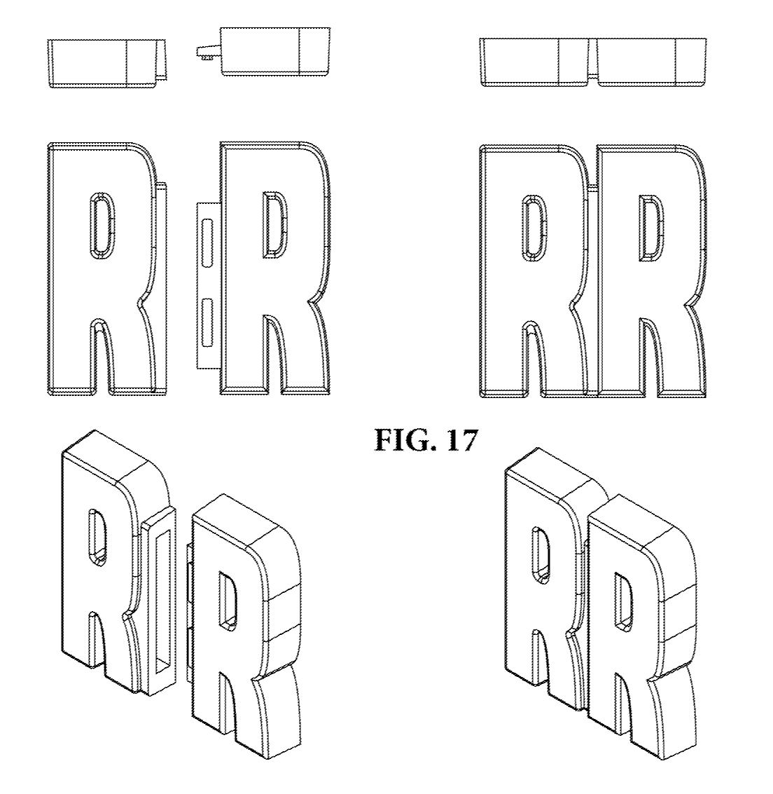

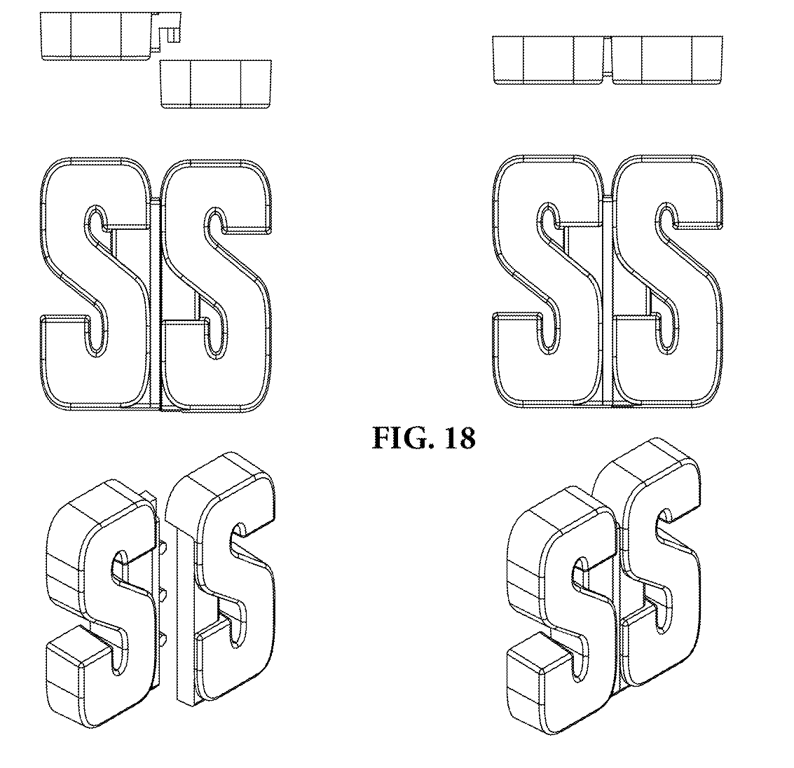

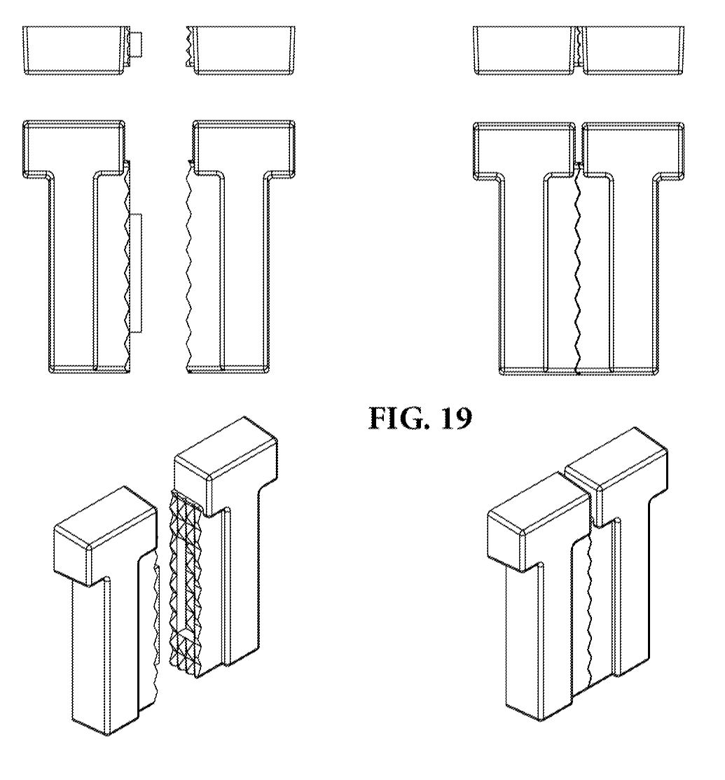

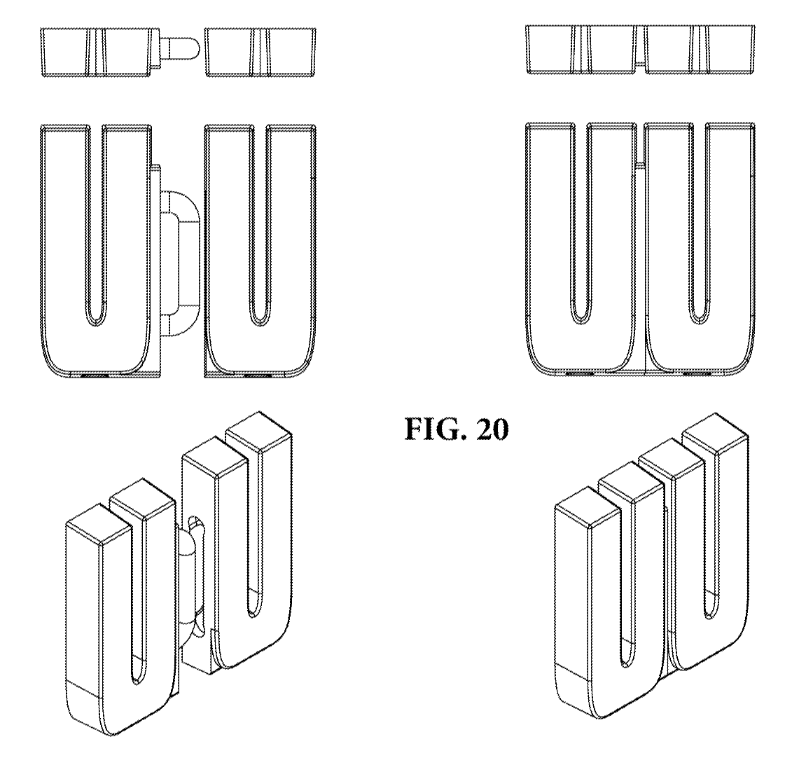

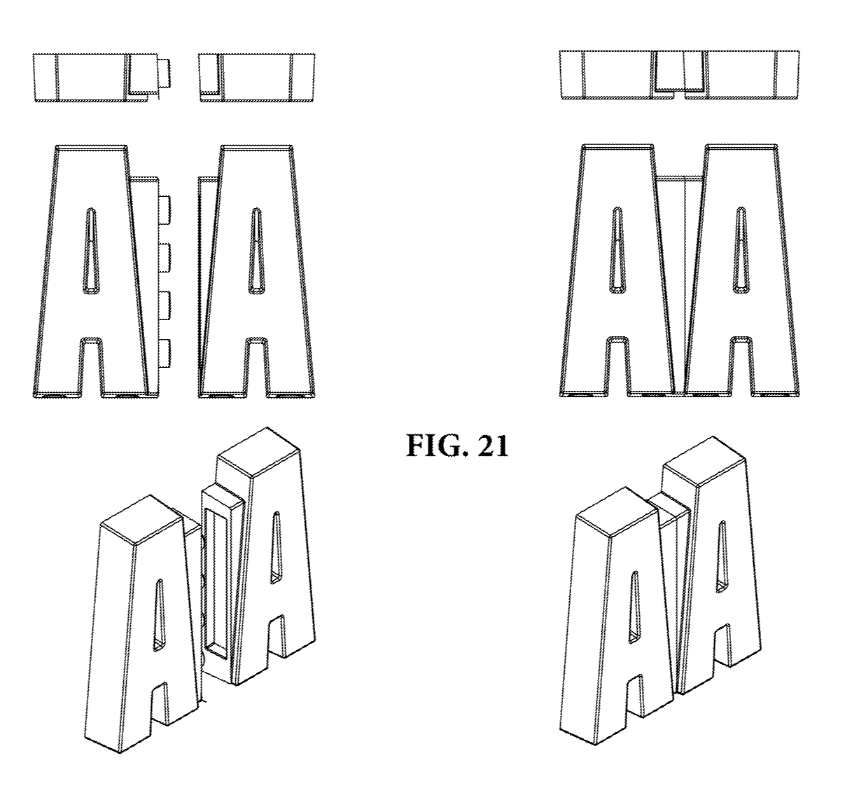

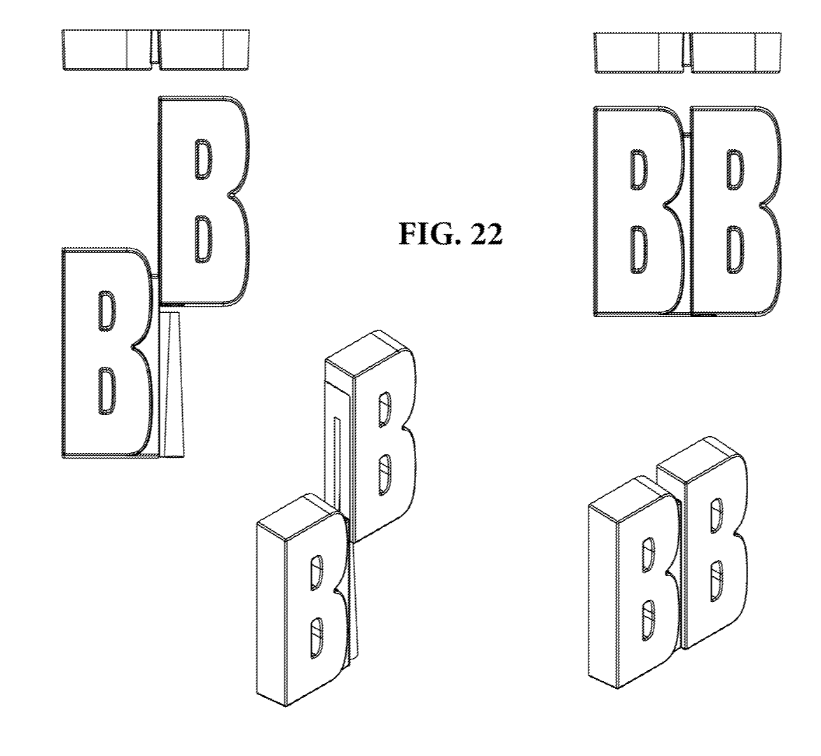

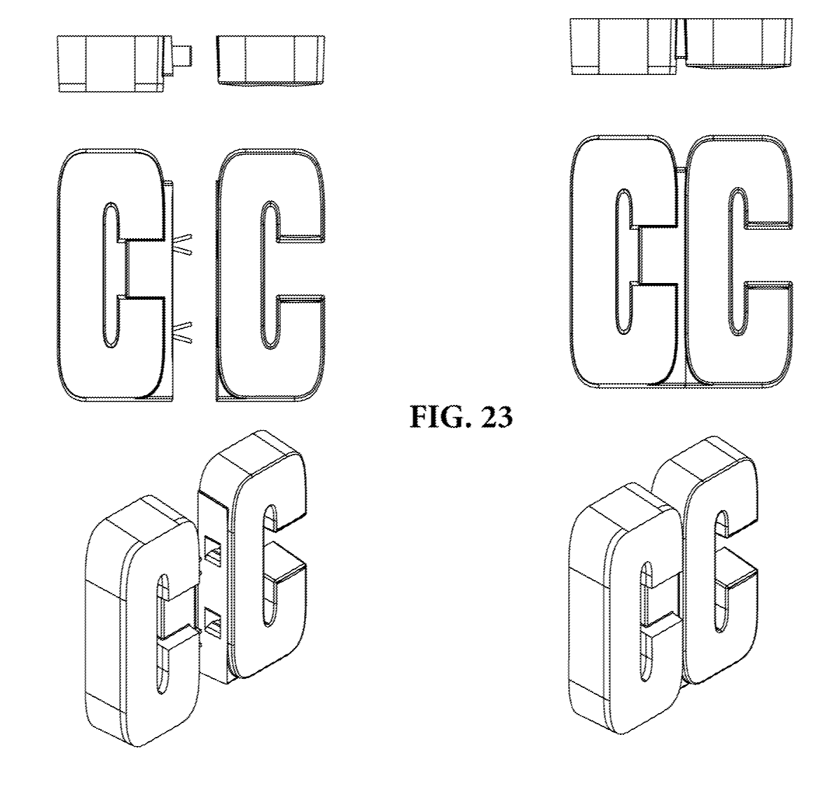

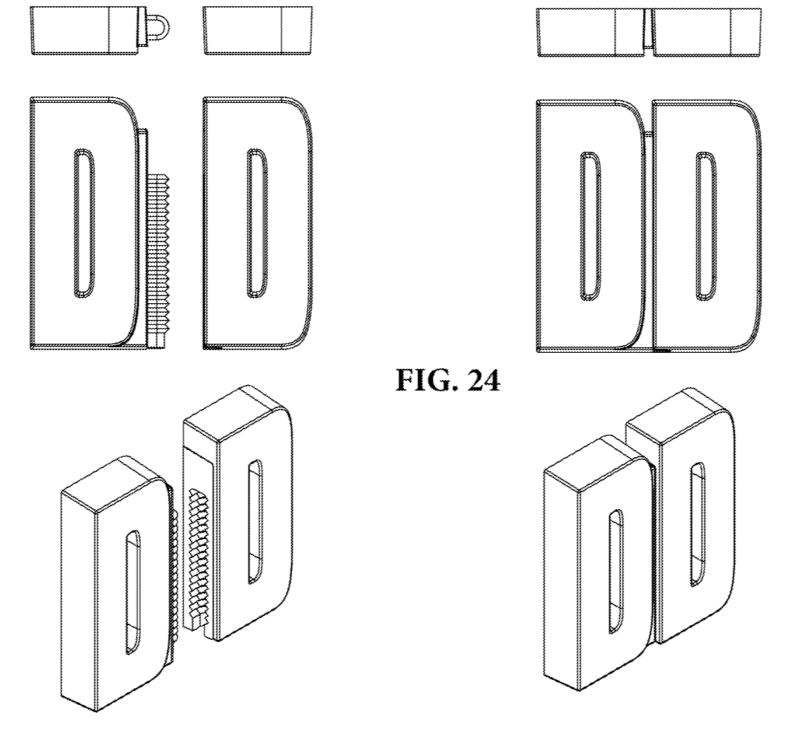

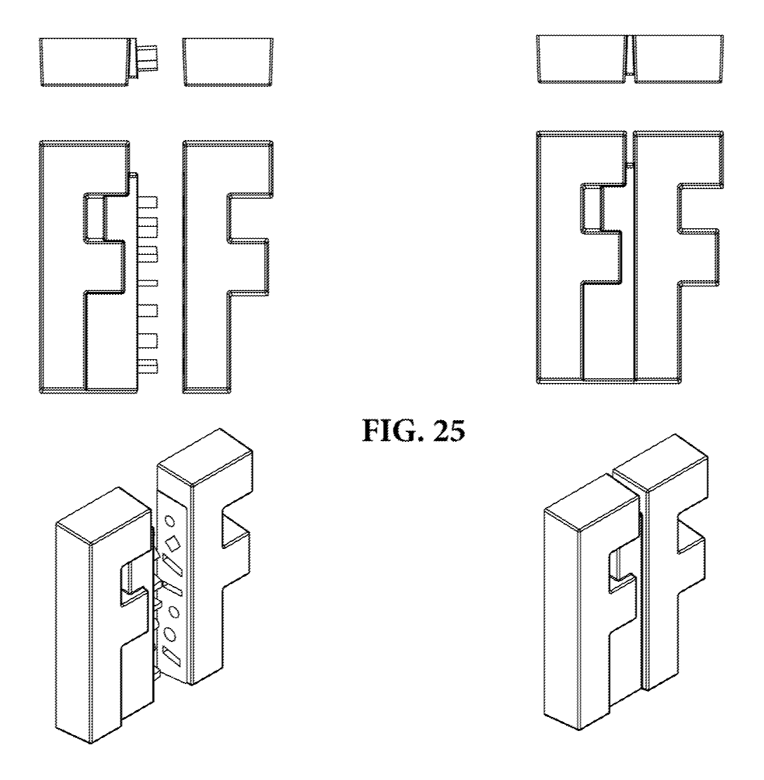

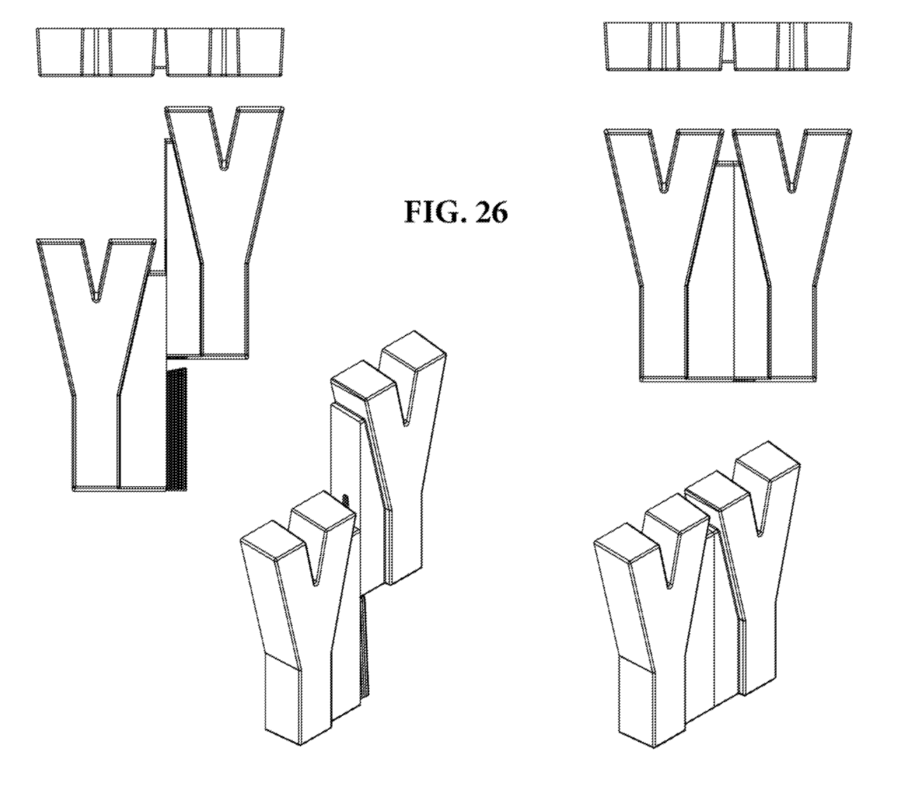

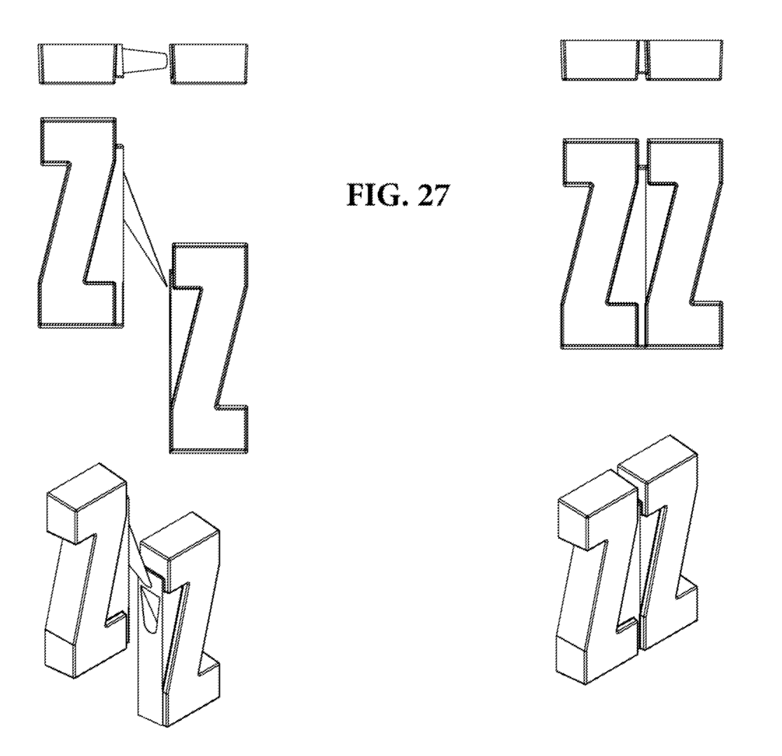

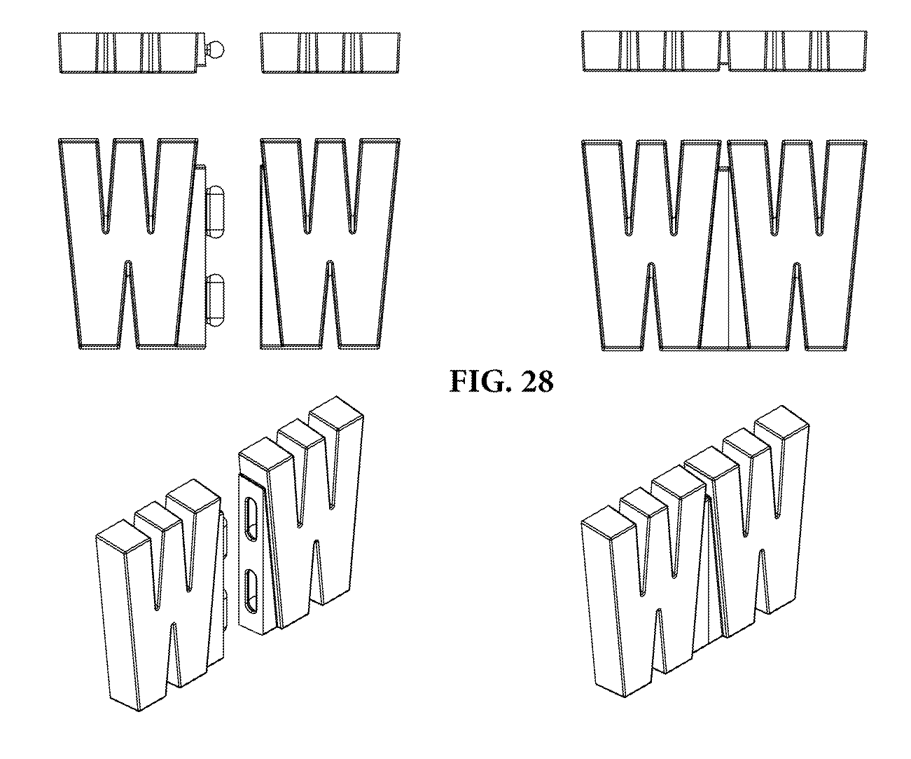

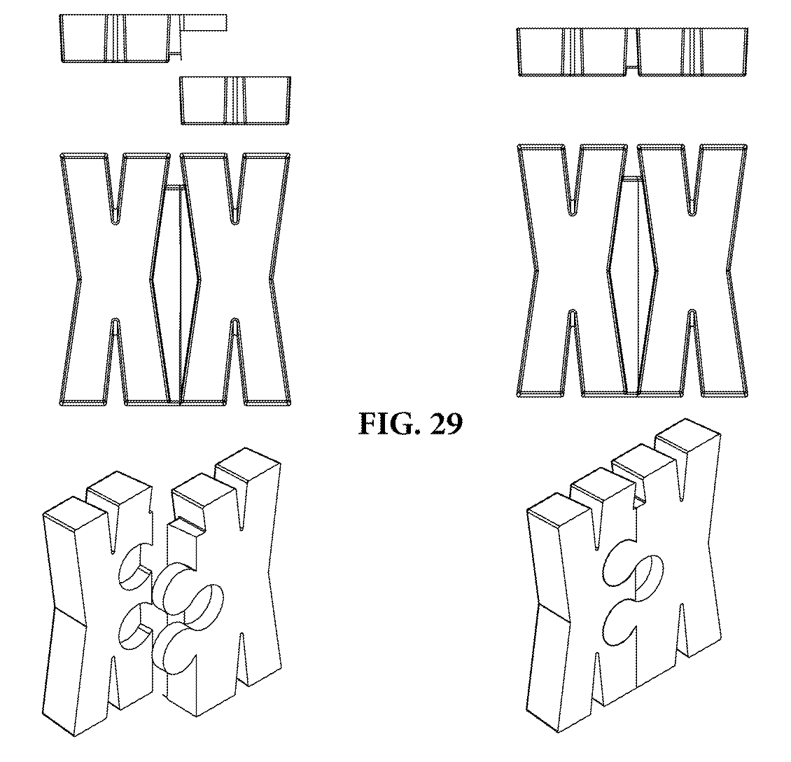

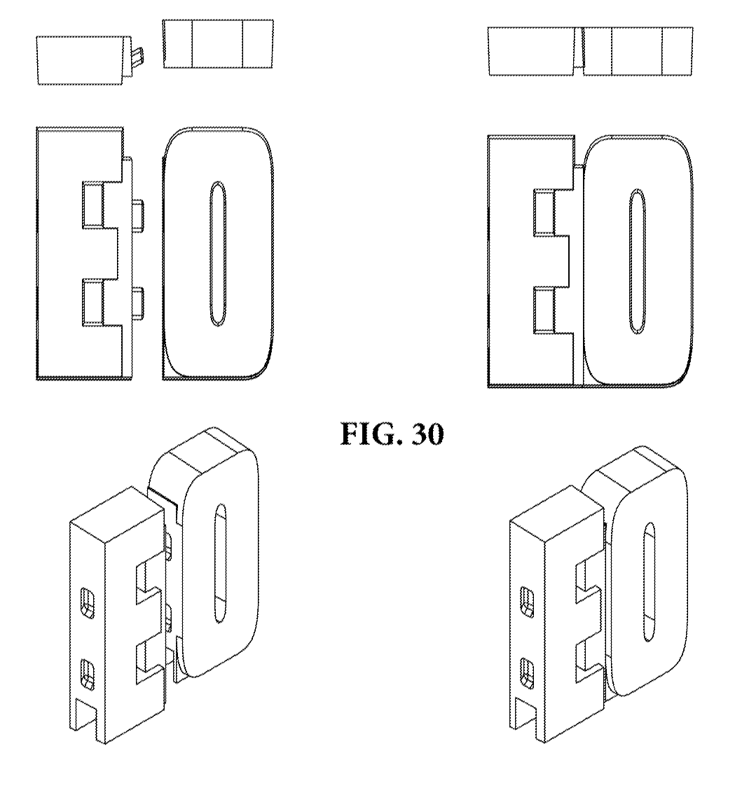

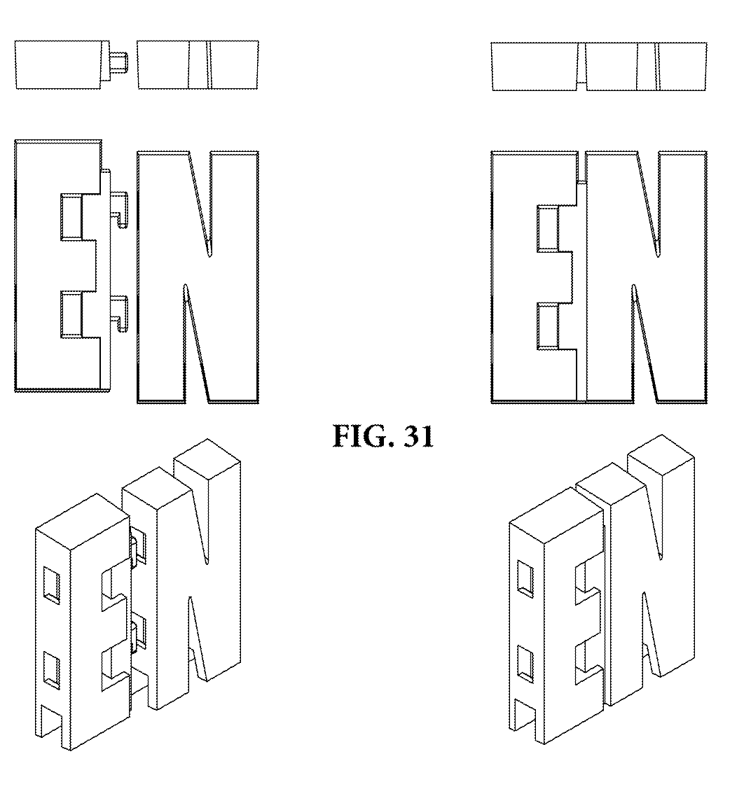

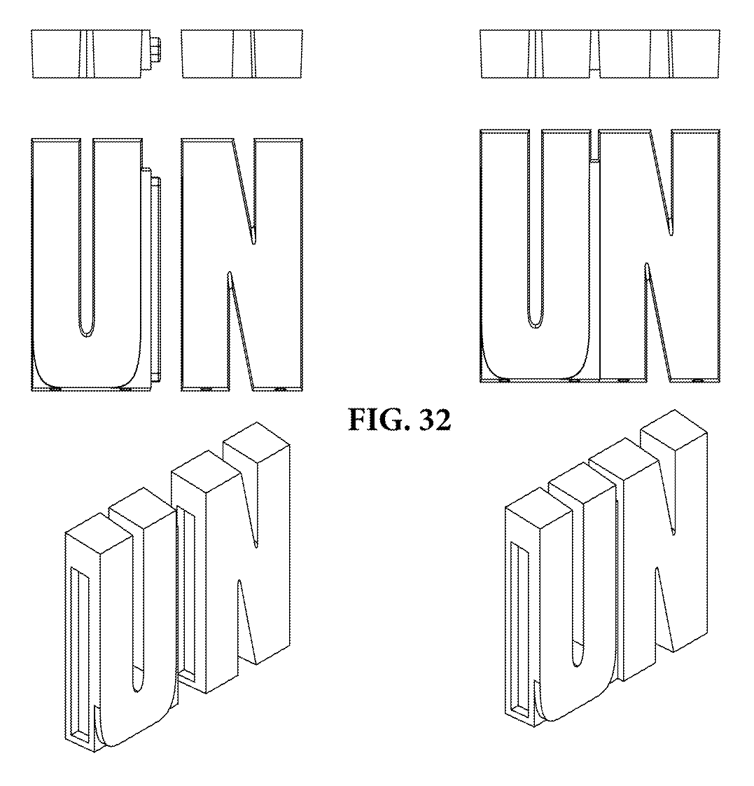

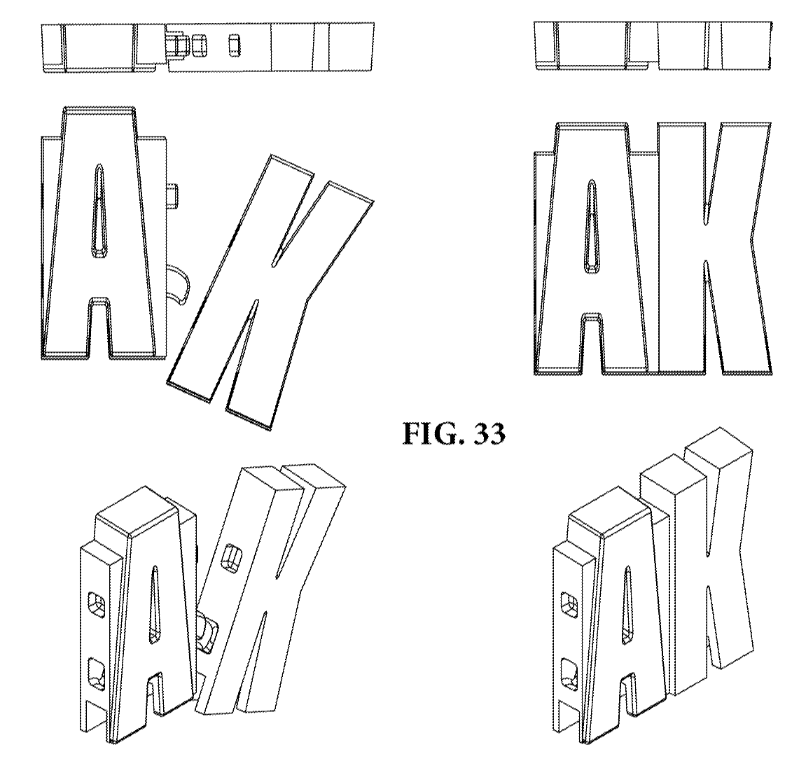

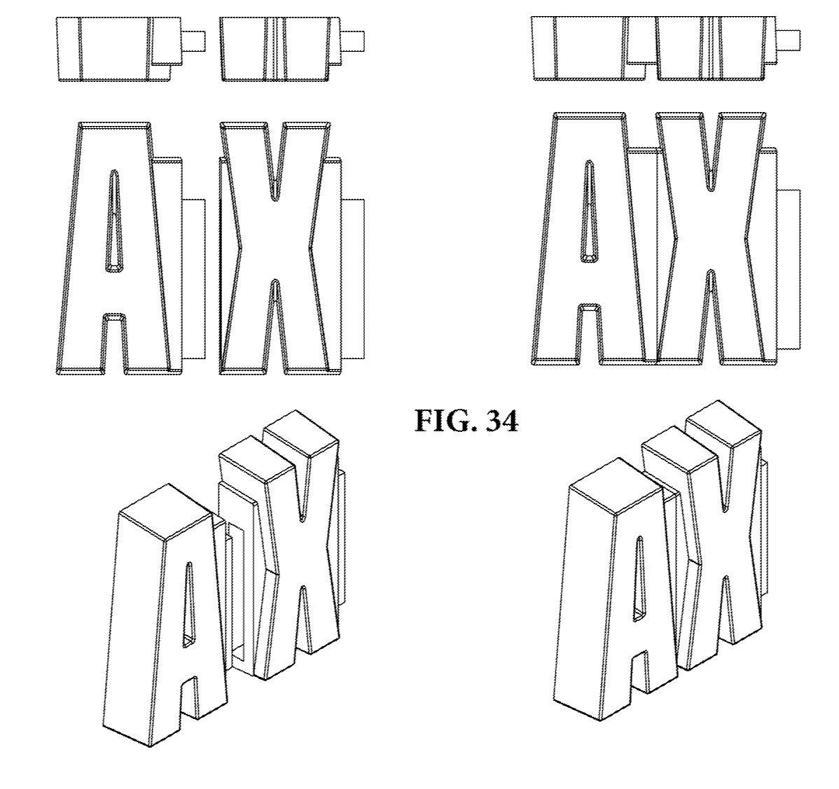

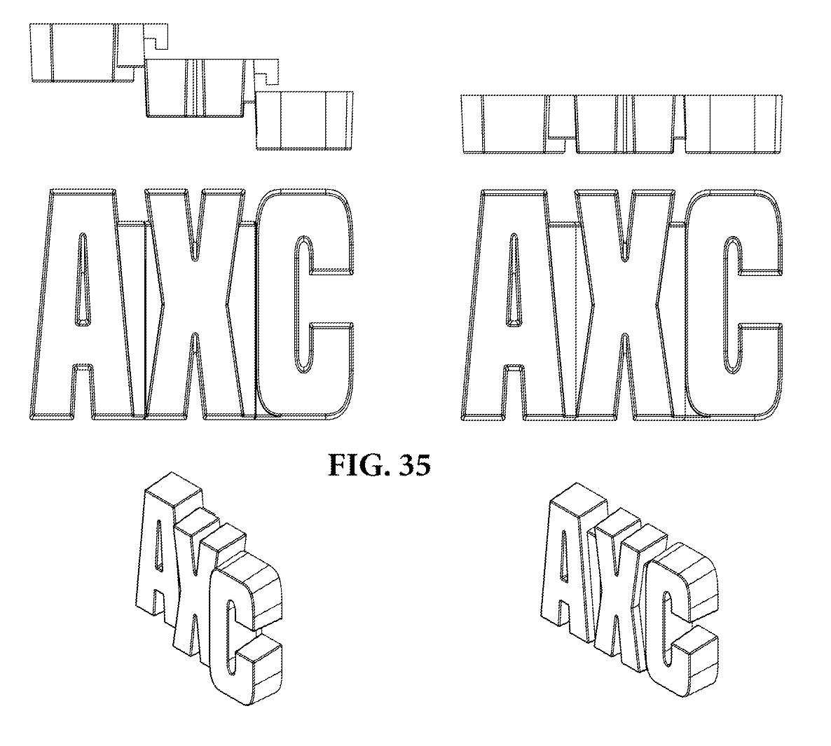

Any particular candle design can be broken down into a set of interchangeable and interlocking pieces that can be used across an entire collection. These pieces may include, e.g., letters and numbers. Each piece features an integral interlocking mechanism, enabling the letters and numbers to be transposed in any necessary order. According to various embodiments of the present invention, various interlocking pieces are shown in FIGS. 6-35. Each of FIGS. 6-35 show various views of interlocking pieces having a specific connecting device for connecting the multiple interlocking pieces.

According to step 220, models are made which can be used to create the modular wax molds that, in turn, can be used to create pieces that will make up the final candle. According to an embodiment, the models are printed using stereolithographic (SLA) 3D printing technology (SLA 3D printer 430 shown in FIG. 5) and are made of a plastic resin or laser sintered nylon. It is noted, however, that other types of 3D printing technology may also be implemented while maintaining the spirit of the present invention. It is also noted that the models may include other suitable materials while maintaining the spirit of the present invention.

At step 225, once the model has been printed and undergoes any post-processing (curing, polishing, removal of support materials, etc.), a silicone mold of the model is made. It is noted, however, that other materials may also be used in the formation of the molds, while maintaining the spirit of the present invention. According to an embodiment, this mold is made manually, using accepted and well documented practices for making RTV (room temperature vulcanizing) silicone molds for wax injection. This mold will be the vessel which will accept the wax and ultimately create the candle components.

The mold making process for each piece may include, but is not limited to, mixing the silicone rubber, removing bubbles from the silicone with vacuum degassing, pouring the silicone over the model and injection sprues, into a mold box (wherein sprues are support items placed in a mold box to hold a model in place and subsequently create the channels which allow the injected wax to fill up the cavity of the mold), allowing the silicone to set, cutting the mold to reveal the model, removing the model and sprues, and/or cleaning the mold. It is noted, however, that other methods of producing the molds may also be used while maintaining the spirit of the present invention. Once the mold is completed, it is ready to be used for the injection of the wax.

At step 230, the individual wax pieces are formed. As noted above, the finished candle is comprised of individual wax pieces which feature an integral interlocking mechanism, allowing the letters and numbers to be transposed in any necessary order. These pieces are made by casting the wax, via injection, into the molds, by clamping the mold shut using a series of clamps and plates, injecting molten wax into the mold via the sprue opening in the mold, allowing the wax to cool and solidify, releasing the clamps, opening the mold and extracting the wax piece, and removing the excess wax from the sprue contact points.

At step 235, the wick or wicks are set in the candle. It is noted that, depending on candle design, the wicks will either be added after the component is extracted from the mold or incorporated into and set inside the mold prior to injection.

According to an embodiment, one or more wick option may be presented to the user prior to purchasing the candle. These options may include, but are not limited to, a sparkler wick (which must be inserted into candle after is extracted from the mold, through use of pressure (pushing it into the desired location) or heat (heating the bottom end of the metal rod and then using pressure to insert)), a standard wick—tabbed (a cotton or paper with a metallic tab (similar to a tealight candle or the metallic end of a boot lace)—Can be integrated into mold design (the wick is placed into the desired location within the mold before injection and is already attached when the candle is extracted) or attached after candle fabrication through pressure or heat, like a sparkler wick), a standard wick—untabbed (just the cotton or paper wick—Must be incorporated into the mold), and/or any other appropriate wick.

The individual parts made using steps 210-235 fit together and are secured by a plurality of methods in the final candle assembly. According to an embodiment, these methods include the mechanical locking mechanism inherent to the interlocking design—meant to secure and align the letters correctly in order to accommodate a connection using an adhesive used to permanently bond the separate pieces together.

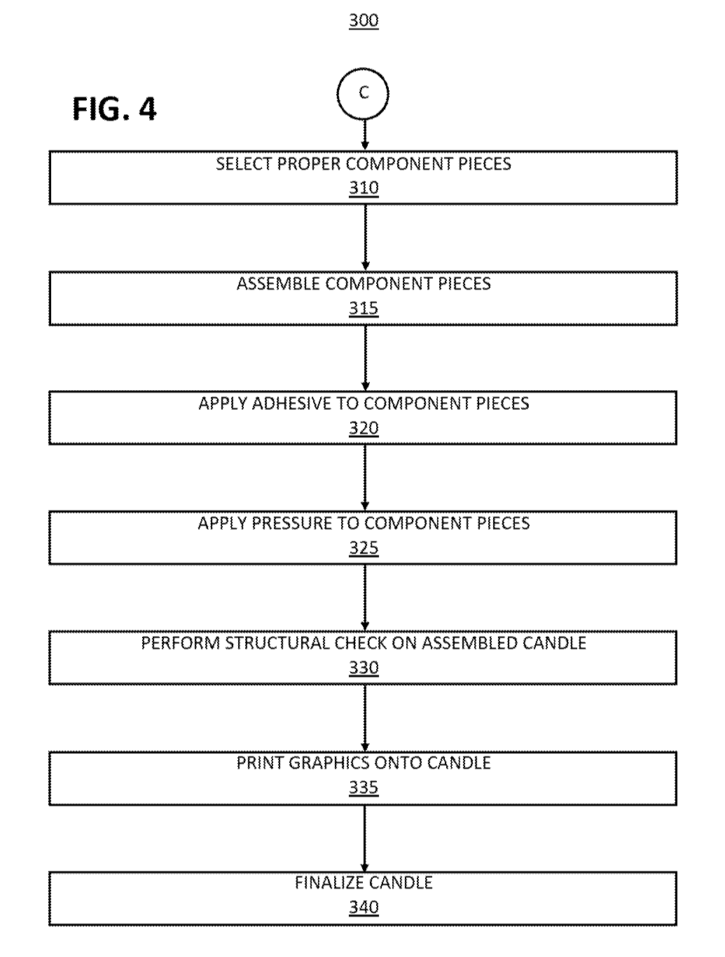

Referring now to FIG. 4, a method 300 of assembling a candle is illustratively depicted, in accordance with an embodiment of the present invention.

At step 310, the proper component pieces are selected. These pieces will make up the assembled candle.

At step 315 the component pieces are assembled in a proper order (depending on the candle design, this step may or may not involve placement of the wick or wicks) and, at step 320, an adhesive is applied to the component pieces. At step 325, pressure is applied to the component pieces to secure the bond formed using the adhesive. In another embodiment, step 320 may precede step 315.

At step 330, once the candle has been assembled and a wick is attached (if necessary), a final structural check is conducted to ensure that the candle is of good quality before it is sent on to printing.

At step 335, the 2D image of the graphics, overlaid onto the 3D rendering of the front face of the candle, is used to print the graphics onto the candle using a graphics printer 470 (shown in FIG. 5). According to an embodiment, multiple jobs (candles) can be printed simultaneously via the use of a prefabricated jig (holding tray).

The individual candles will be placed into a tray (size and capacity will be determined by the number and size of the candles). Their positions on the tray will be input into the printers Raster Image Processor (RIP) software. For instance, Job abc, assigned to position 1, job xyz, assigned to position 2, job jkl, assigned to position 3, etc. The RIP software will be able to read the dimensions of the candle and the requirements of the print job from the image files associated with the candle axed will print graphics onto the faces of the candle with UV curable ink, which has been approved for food contact and deemed safe for accidental ingestion.

This ink cures approximately instantaneously. Once the printer has completed the print job, a final inspection of the candle will be made, at step 340, and the product is ready for packaging and shipment to the user.

Referring now to FIG. 5, a system 500 for manufacturing candles is illustratively depicted in accordance with an embodiment of the present principles. According to an embodiment, the system 500 functions under a standard work flow. However, one or more of the components of the system 500 may function at any time during the manufacturing of the one or more candles.

According to an embodiment, the system 500 includes multiple components which can be used to perform any or all of the steps describes herein in FIGS. 1-4.

According to an embodiment, the system includes an electronic device 411 having a graphical user interface 412, the electronic device 411 being configured to enable a user to determine the parameters for a candle or multiple candles to be manufactured.

According to an embodiment, the system 500 includes a mold making system. The told making system may include one or more 3D printers 430 having one or more 3D printing supplies 432. The mold making system may further include silicone storage 434, measuring equipment 436, mixing equipment 438, a vacuum 440, a pour station 442, a mold box and wicking station 444, mold box storage 446, an uncured silicone shelf 448, and/or a heating system 450.

According to an embodiment, the system 500 includes an injection system. The injection system may include a mold storage 452, an auto injector 454, a wax storage 456, a cooling system 458, a wax letter clean up station 460, and/or room cleaning supplies 462. In another embodiment, the auto injector 454 may also be a manual injector.

According to an embodiment, the system 500 includes an assembly system for assembling the candles. The assembly system may include a wax letter storage 464, an assembly area 466, a printer queue 468, an image/graphics printer 470, and a quality control station 472

According to an embodiment, the system 500 further includes a shipping system for shipping the completed candles. The shipping system includes a packaging and shipping preparation station 474 and a shipping queue and collection area 476.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A method for manufacturing candles, comprising:
receiving, using a graphical user interface, a set of candle specifications input by a user;
creating a 3-dimensional data file based on the set of candle specifications;
printing, using a 3-dimensional printer, one or more models corresponding to one or more pieces of a candle;
forming one or more molds corresponding to the one or more models;
casting one or more wax pieces using the molds; and
assembling the one or more wax pieces.

2. The method as recited in claim 1, wherein the set of candle specifications includes one or more input variables selected from the group consisting of:
wax type;
candle size;
lettering;
numbering;
visual graphics;
wick type;
shape of candle; and
number of wicks.

3. The method as recited in claim 2, wherein the visual graphics include one or more image files.

4. The method as recited in claim 3, wherein the receiving further includes:
uploading the one or more image files.

5. The method as recited in claim 2, further comprising:
printing the visual graphics onto the candle.

6. The method as recited in claim 1, wherein the graphical user interface is housed on a mobile electronic device.

7. The method as recited in claim 1, wherein the 3-dimensional printer is a stereolithographic printer.

8. The method as recited in claim 7, wherein the one or more models include one or more materials selected from the group consisting of: plastic resin; and laser sintered nylon.

9. The method as recited in claim 1, wherein the assembling the one or more wax pieces further includes:
applying an adhesive to the one or more wax pieces.

10. The method as recited in claim 9, wherein the assembling the one or more wax pieces further includes:
applying a pressure to each of the one or more wax pieces.

11. A system for manufacturing candles, comprising:
an electronic device, including:
a graphical user interface configured to receive a set of candle specifications input by a user;
a processor, coupled to a memory, configured to create a 3-dimensional data file based on the set of candle specifications; and
a 3-dimensional printer configured to print one or more models corresponding to one or more pieces of a candle, wherein the one or more models are configured to enable one or more molds to be formed from the one or more models.

12. The system as recited in claim 11, wherein the set of candle specifications includes one or more input variables selected from the group consisting of:
wax type;
candle size;
lettering;
numbering;
visual graphics;
wick type;
shape of candle; and
number of wicks.

13. The system as recited in claim 12, wherein the visual graphics include one or more image files.

14. The system as recited in claim 13, wherein the graphical user interface is further configured to enable a user to upload the one or more image files.

15. The system as recited in claim 12, further comprising:
a graphics printer configured to print the visual graphics onto the candle.

16. The system as recited n claim 11, wherein the graphical user interface is housed on a mobile electronic device.

17. The system as recited in claim 11, wherein the 3-dimensional printer is a stereolithographic printer.

18. The system as recited in claim 17, wherein the one or more models include one or more materials selected from the group consisting of: plastic resin; and laser sintered nylon.

19. The system as recited in claim 11, further comprising an adhesive configured to secure one or more wax pieces formed from the one or more molds.

20. The system as recites in claim 11, wherein two or more of the one or more pieces of the candle include an interlocking mechanism for interlocking the two or more pieces.
